(19) United States
(12) Patent Application Publication
(10) Pub. No.: US 2008/0164183 A1
(43) Pub. Date: Jul. 10, 2008

(54) Collection system for a wet drum magnetic separator

(76) Inventors: Peter G. Marston, Ipswich, MA (US); Ionel Wechsler, Framingham, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/893,255

(22) Filed: Aug. 15, 2007

Related U.S. Application Data
(60) Provisional application No. 60/879,373, filed on Jan. 9, 2007.

(51) Int. Cl. B03C 1/03

(52) U.S. Cl. 209/214

(57) ABSTRACT

An improved collection system for a wet drum magnetic separator including a tank for receiving a flow of a mixture of magnetic and non-magnetic particles in a feed port. A collection system includes a rotating drum having a roughened collection surface disposed in the tank, an array of permanent magnetic elements disposed inside the drum arranged in a fixed position relative to an azimuthal section of the drum for establishing an azimuthal magnetic interaction region defined by a level of the mixture in the tank for attracting the magnetic particles to the roughened collection surface, a non-magnetic particle discharge port located on an opposite side of the tank that receives the flow for removing the non-magnetic particles, a magnetic particle discharge port located outside the tank for receiving the magnetic particles, and a magnetic particle removal subsystem for removing the magnetic particles trapped in the roughed collection surface and dispensing the magnetic particles to the magnetic particle discharge port.

### RELATED APPLICATIONS

This application claims the benefit of and priority to U.S. Provisional Application No. 60/879,373, filed Jan. 9, 2007, which is incorporated by reference herein.

### FIELD OF THE INVENTION

This invention relates to an improved collection system for a wet drum magnetic separator.

### BACKGROUND OF THE INVENTION

Wet drum magnetic separators are often used in the mining industry for recovering magnetic particles, e.g., magnetite, from iron ore. This is achieved by grinding the iron ore to a fine powder having particles sized typically less than about 70 microns. The fine grinding liberates the magnetic particles from other elements in the ore. The mixture of the magnetic and non-magnetic particles is slurried in water and fed to a wet magnetic drum separator where the more magnetic particles are extracted from the slurry leaving the less magnetic particles to be discharged as non-magnetic tailings.

A typical wet drum magnetic separator includes of an array of permanent magnetic elements disposed inside the lower portion of cylindrical drum. The drum rotates in a tank which is continuously filled with the slurry-water mixture of magnetic and non-magnetic particles. The array of permanent magnetic elements inside the drum is kept in a fixed position close to the surface of the drum while the drum rotates in the tank. The more magnetic particles are extracted from the slurry by adhering to the surface of the drum in the region of the magnetic field created by the array of permanent magnets while the less or non-magnetic particles remain in the slurry. The slurry depleted of the magnetic particles is discharged to a non-magnetic particle discharge port and magnetic particles are discharged into a magnetic particle discharge port as they leave the magnetic field of the array of permanent magnets.

There are generally two types of conventional wet drum magnetic separators: concurrent and counter-current. Concurrent wet drum magnetic separators rotate the drum in the same direction as the flow of the slurry and counter-current wet drum magnetic separators rotate the drum in an opposite direction as the flow of the slurry. Counter-current wet drum magnetic separators are typically used to improve recovery of the magnetic-particles in the mixture.

A typical conventional concurrent wet drum magnetic separator has the feed input on one side of the drum and the magnetic and non-magnetic particle discharge ports on the other side of the drum. A typical conventional counter-current wet drum magnetic separator has the feed input and the magnetic particle discharge particle port on one side of the drum and the non-magnetic particle discharge port on the other side of the drum. The result of such designs is the inability to utilize the full azimuthal shape of the array of permanent magnets defined by the slurry level in the tank. This results in a limited azimuthal magnetic interaction region for attracting magnetic particles in the mixture. Typical concurrent and counter-current wet drum magnetic separators have an azimuthal magnetic interaction region of about 60° to 90°. Such a limited azimuthal magnetic interaction region limits the recovery of magnetic particles and the processing capacity of these systems.

Conventional concurrent and counter-current wet drum magnetic separators also have a complex design which results in a complicated flow path or the slurry which further reduces processing capacity and increase manufacturing costs.

Ballasted flocculation and sedimentation processes and/or surface adsorption processes, such as those disclosed in U.S. Pat. Nos. 4,427,550 and 4,981,583 to Priestley et al. and U.S. Pat. No. 6,099,738 to Wechsler et al., each incorporated by reference herein, may utilize a concurrent and counter-current wet drum magnetic separator to recover magnetic ballasts, such as magnetite and similar type ballasts, from the effluent of these processes. Therefore, the problems associated with conventional concurrent and counter-current rotating wet drum magnetic separators similarly affect these processes.

### BRIEF SUMMARY OF THE INVENTION

It is therefore an object of this invention to provide an improved collection system for a wet drum magnetic separator.

It is a further object of this invention to provide such a collection system which increases the available azimuthal magnetic interaction region.

It is a further object of this invention to provide such a collection system which utilizes virtually the entire magnetic field provided by an azimuthally shaped array of permanent magnets.

It is a further object of this invention to provide such a collection system which increases recovery of magnetic particles.

It is a further object of this invention to provide such a collection system which increases yield.

It is a further object of this invention to provide such a collection system which increases processing capacity.

It is a further object of this invention to provide such a collection system which has a less complicated flow path for a flow of a mixture of magnetic and non-magnetic particles.

It is a further object of this invention to provide such a collection system which is less complex.

It is a further object of this invention to provide such a collection system which is less expensive.

It is a further object of this invention to provide such a collection system which reduces processing costs.

The subject invention, however, in other embodiments, need not achieve all these objectives and the claims hereof should not be limited to structures or methods capable of achieving these objectives.

This subject invention features an improved collection system for a wet drum magnetic separator including a tank for receiving a flow of a mixture of magnetic and non-magnetic particles in a feed port. A collection system includes a rotating drum having a roughened collection surface disposed in the tank, an array of permanent magnetic elements disposed inside the drum arranged in a fixed position relative to an azimuthal section of the drum for establishing an azimuthal magnetic interaction region defined by a level of the mixture in the tank for attracting the magnetic particles to the roughened collection surface, a non-magnetic particle discharge port located on an opposite side of the tank as the flow of the mixture for removing the non-magnetic particles, a magnetic particle discharge port located outside the tank for receiving the magnetic particles, and a magnetic particle removal subsystem for removing the magnetic particles trapped in the roughed collection surface and dispensing the magnetic particles to the magnetic particle discharge port.

In one embodiment, the azimuthal magnetic interaction region may be subtended at an angle in the range of about 100° to 240° with respect to the center of the drum. The azimuthal magnetic interaction region may be subtended at an angle of 160°. The flow of the mixture is fed at a flow rate in the range of about 120 gpm to about 400 gpm. The flow of the mixture is fed at a flow rate of about 150 gpm. The magnetic particle removal subsystem may include a scraper engaged with the roughened collection surface. The scraper may include a plurality of wheels disposed on the roughened collection surface of the drum.

The scraper may include a support arm attached to the tank. One end of the scraper may include a surface contoured to the shape of the roughened collection surface of the drum.

The magnetic particle removal subsystem may include at least one spray nozzle for dispensing a fluid on the roughened collection surface to enhance removal of the magnetic particles. The roughened collection surface may include wire mesh, which may be made of a non-magnetic material that may include stainless steel or by VELCRO®. The drum may rotate counter-current or concurrent the direction of the flow of the mixture. The magnetic particles may include magnetite.

This invention also features an improved collection system for a counter-rotating wet drum magnetic separator includes a tank for receiving a flow of a mixture of magnetic and non-magnetic particles in a feed port. A collection system including a rotating drum having a roughened collection surface disposed in thee tank, an array of permanent magnetic elements disposed inside the drum arranged in a fixed position relative to an azimuthal section of the drum for establishing an azimuthal magnetic interaction region defined by a level of the mixture in the tank for attracting the magnetic particles to the roughened collection surface, a non-magnetic particle discharge port located on an opposite side of the tank as the flow of the mixture for removing the non-magnetic particles, a magnetic particle discharge port located outside the tank for receiving the magnetic particles, and a magnetic particle removal subsystem for removing the magnetic particles trapped in the roughed collection surface and dispensing the magnetic particles to the magnetic particle discharge port.

This invention also features an improved collection system for a concurrent wet drum magnetic separator includes a tank for receiving a flow of a mixture of magnetic and non-magnetic particles in a feed port. A collection system includes a rotating drum having a roughened collection surface disposed in the tank, an array of permanent magnetic elements disposed inside the drum arranged in a fixed position relative to an azimuthal section of the drum for establishing an azimuthal magnetic interaction region defined by a level of the mixture in the tank for attracting the magnetic particles to the roughened collection surface, a non-magnetic particle discharge port located on an opposite side of the tank as the flow of the mixture for removing the non-magnetic particles, a magnetic particle discharge port located outside the tank for receiving the magnetic particles, and a magnetic particle removal subsystem for removing the magnetic particles trapped in the roughed collection surface and dispensing the magnetic particles to the magnetic particle discharge port.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1A is a three-dimensional view of a conventional wet drum magnetic separator;

FIG. 1B is a three-dimensional view showing the primary components of the conventional wet drum magnetic separator shown in FIG. 1A;

FIG. 1C is a three-dimensional view shown in further detail the array of permanent magnets shown in FIG. 1B;

FIG. 2 is a schematic side-view showing the flow of a mixture of magnetic and non-magnetic particles for a typical conventional concurrent wet drum magnetic separator;

FIG. 3A is a schematic end view showing the flow of a mixture of magnetic and non-magnetic particles for a typical conventional counter-current wet drum magnetic separator;

FIG. 3B is a schematic end view showing an exemplary trajectory path of magnetic particles relative to the azimuthal magnetic interaction region A shown-in FIG. 2A;

FIG. 3C is a schematic end view showing an exemplary trajectory path of magnetic particles relative to the azimuthal magnetic interaction region B shown in FIG. 2A;

FIG. 4 is a schematic side-view of one embodiment of the improved collection system for a wet drum magnetic separator in accordance with this invention;

FIG. 5 is a schematic side-view showing in further detail the increased azimuthal magnetic interaction region shown in FIG. 4;

FIG. 6 is a schematic end view showing the trajectory path of exemplary magnetic particles relative to the increased azimuthal magnetic interaction region of this invention shown in FIGS. 4 and 5;

FIG. 7 is a schematic side-view showing one example of the roughened drum surface shown in FIG. 4;

FIG. 8A is a three-dimensional top view showing in further detail the structure of one embodiment of the magnetic particle removal subsystem shown in FIG. 4;

FIG. 8B is a schematic side-view of the scraper subsystem shown in FIG. 8A; and

FIG. 8C is a schematic side-view showing in further detail the interface between the scraper and the drum shown in FIGS. 8A-8C.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

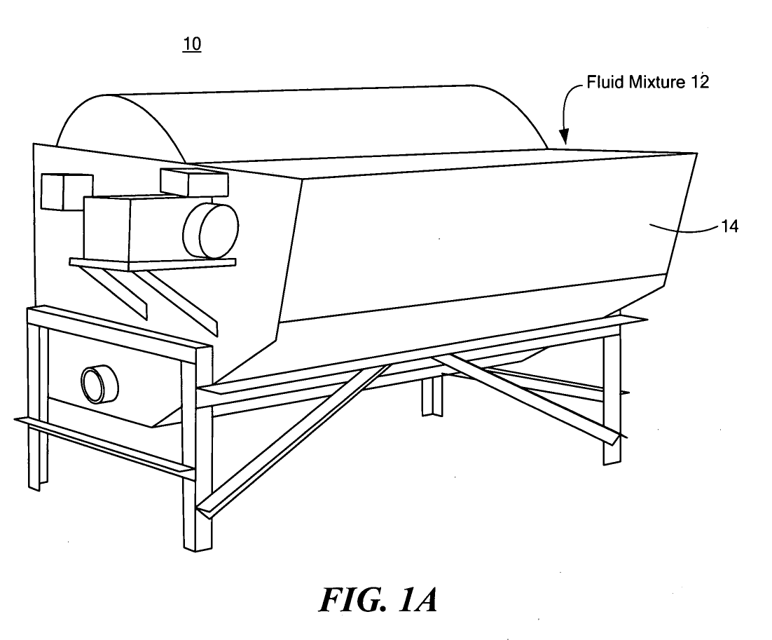

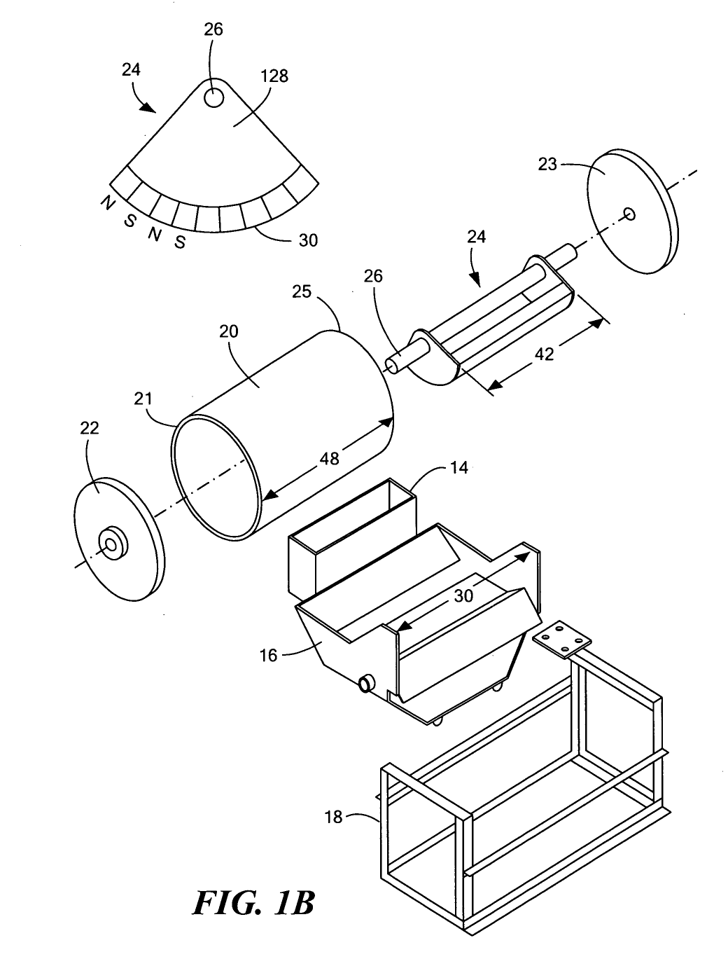

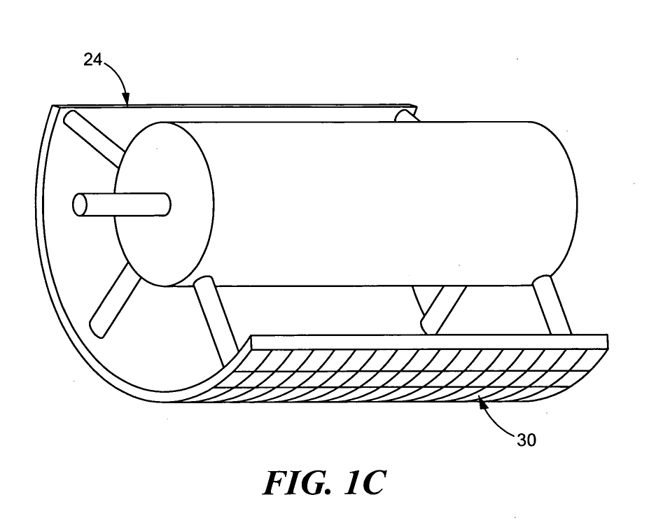

Conventional wet drum magnetic separator 10, FIG. 1A, is typically used to separate magnetic particles from non-magnetic particles in fluid mixture 12 which is fed into feed box 14. Fluid mixture 12 may be a feed slurry of magnetic and non-magnetic particles or an effluent having magnetic ballasts resulting from flocculation and sedimentation processes and/or adsorption processes. Wet drum magnetic separator 10 includes tank 16, FIG. 1B, with feed box 14. Tank 16 is supported by support frame 18. Drum 20 is disposed in tank 16. Array of permanent magnets 24 is disposed inside drum 20 and drum heads 22 and 23 are secured to ends 21 and 25, respectively. Array of permanent magnets 24 includes shaft 26 disposed through hanger 28 and a plurality of magnetic elements 30 attached to hanger 28. FIG. 1C shows in further detail one example of the axial and azimuthal arrangement of magnetic elements 30 on array of permanent magnets 24.

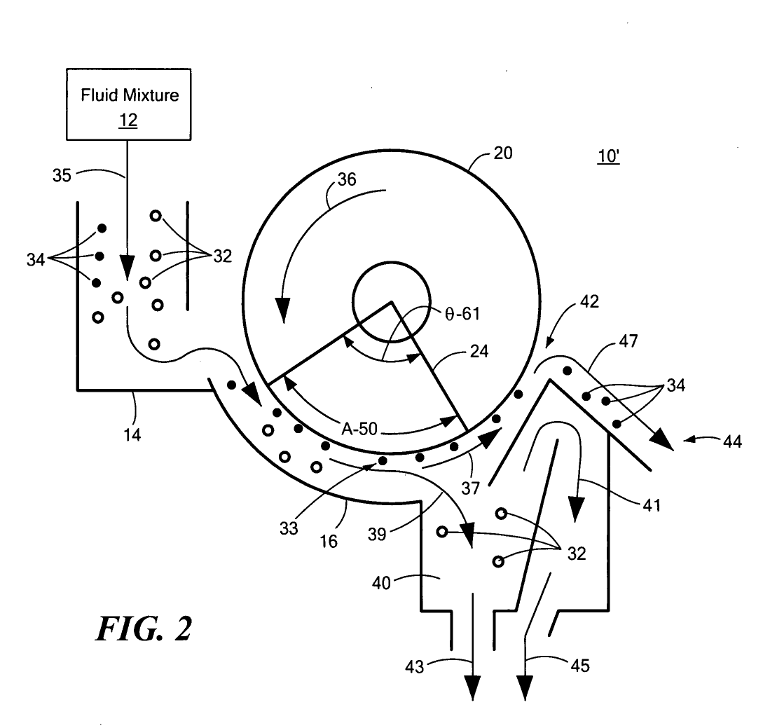

Conventional concurrent wet drum magnetic separator 10′, FIG. 2, where like parts have been given like numbers, similarly includes feed box 14, tank 16, drum 20, and array of permanent magnets 24. In operation, fluid mixture 12 is fed into feed box 14. Fluid mixture 12 with non-magnetic particles 32 and magnetic particles 34 flows in the direction of arrow 35 and drum 20 rotates concurrent to the flow of fluid mixture 12, indicated by arrow 36. Array of permanent magnets 24 is maintained in a fixed position relative to tank 16. As fluid mixture 12 having a mixture of non-magnetic particles 32 and magnetic particles 34 enters the magnetic field provided by array of permanent magnets 24, magnetic particles 34 adhere to the surface of drum 20, indicated at 33, while non-magnetic particles 32 are discharged through non-magnetic particle discharge port 40. As magnetic particles 32 adhered to the surface of drum 20 leave the magnetic field provided by array of permanent magnets 24, indicated at 42, magnetic particles 34 are discharged to magnetic particle discharge port 44.

However, the design of conventional concurrent rotating magnetic separator 10′ with non-magnetic particle discharge port 40 and magnetic particle discharge port 44 located on the opposite side of drum 20 as feed box 14 and inside tank 14 limits the available azimuthal magnetic interaction region A-50 that can be utilized to recover magnetic particles 34 in fluid mixture 12. In this example, conventional concurrent rotating wet drum magnetic separator 10′ has functional azimuthal magnetic interaction region of about 60° to 90°, indicated by θ-61. The result is concurrent wet drum magnetic separator 10′ does not efficiently-recover magnetic particles 34 in mixture 12 and has a limited processing capacity. Moreover, concurrent wet drum magnetic separator 10′ has a complex flow of fluid mixture 12 indicated by arrows 37, 39, 41, 43, 45 and 47 which further limits flow capacity and increases manufacturing costs.

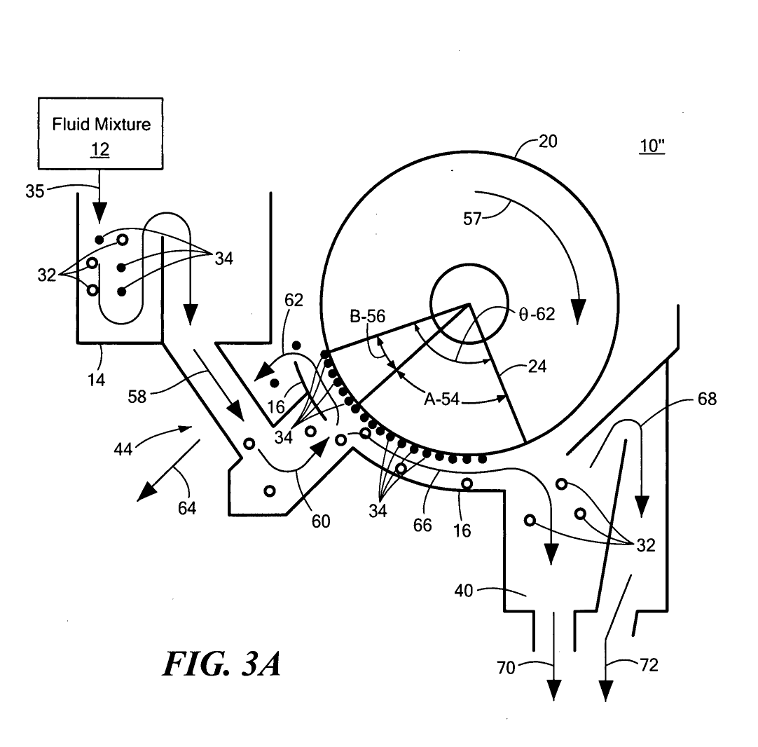

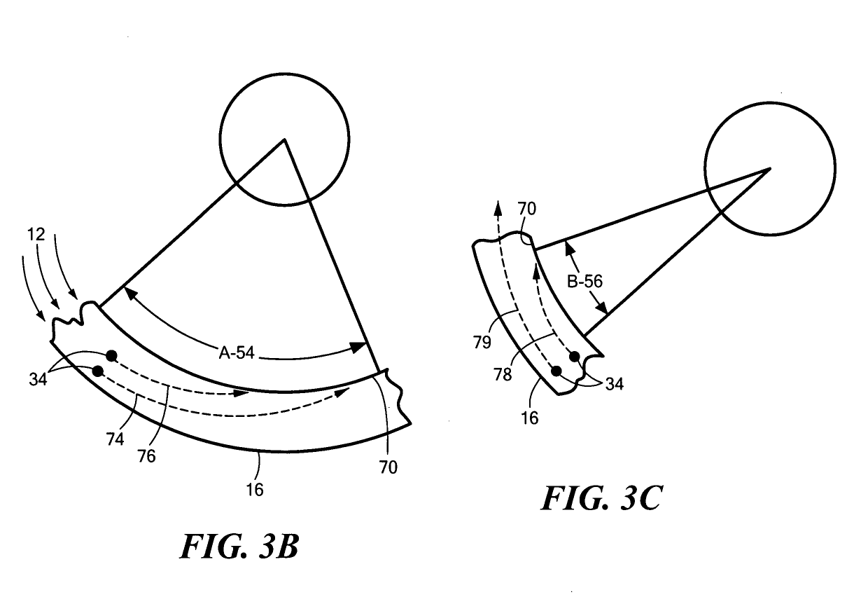

Conventional counter-current wet drum magnetic separator 10″, FIG. 3A, where like parts have been given like numbers, receives fluid mixture 12 with non-magnetic particles 32 and magnetic particles 34 via feed box. 14. Fluid mixture 12 flows in the direction indicated by arrow 35. Drum 20 rotates counter-current the direction of the flow of mixture 12, indicated by arrow 57. Counter-current wet drum magnetic separator 10″ includes magnetic particle discharge port 44 located on the same side of drum 20 as feed box 14 and non-magnetic particle discharge port 40 on the opposite side of drum 20. Similar, as discussed above, array of permanent magnets 24 is maintained in a fixed position relative to tank 16.

In operation, magnetic particles 34 in fluid mixture 12 located in azimuthal magnetic interaction region A-54 adhere to surface 70 of magnetic drum 20 while non-magnetic particles 32 are discharged through non-magnetic particle discharge port 40 as they leave the magnetic field provided by array of permanent magnets 24. Magnetic particles 34 in azimuthal magnetic interaction region B-56 similarly adhere to surface 70 of magnetic drum 20. Magnetic particles 34 which adhere to the surface of drum 20 in azimuthal magnetic interaction regions A-54 and B-56 congregate and form whiskers in region B-56 and are then discharged to magnetic particle discharge port 44 as they leave azimuthal magnetic interaction region B-56.

However, the design of counter-current wet drum magnetic separator 10″ with the location of magnetic particle discharge port 44 and non-magnetic particle discharge port 40 on opposite side of drum 20 and magnetic particle discharge port 44 inside tank 14 limits the available azimuthal magnetic interaction region that can be utilized for the removal of magnetic particles 34. The total azimuthal magnetic interaction region for separator 10″, which includes both region A-54 and region B-56 is typically no greater than about 60° to 90°, indicated by θ-62. Such a design decreases the yield of magnetic particles and limits the processing capacity of separator 10″. Moreover, the flow of mixture 12 is complicated, as shown by arrows 58, 60, 62, 64, 66, 68, 70, and 72 which increases production costs and further reduces processing capacity.

The limited size of azimuthal magnetic interaction regions A-54 and B-56 reduces the processing capacity of separator 10″. This is because there is not enough time for magnetic particles 34 in mixture 12 to adhere to surface 70 of drum 20 before they leave azimuthal magnetic interaction regions A-54 and B56. For example, FIG. 3B shows exemplary trajectory paths 74 and 76 for exemplary magnetic particles 34 in azimuthal magnetic interaction region A-54. Counter-current wet drum magnetic separator 10″ is designed so that magnetic particles 34 of trajectory path 74 adhere to surface 70 of drum 20 before they leave region A-54. Because region A-54 has a limited available azimuthal magnetic interaction region, the flow rate of mixture 12 must be controlled and limited to ensure proper recovery of magnetic particles 34 of trajectory path 74. Similarly, FIG. 3C shows exemplary trajectory paths 78 and 79 of exemplary magnetic particles 34 in region B-56. In this example, magnetic particles 34 of trajectory path 78 reach surface 70 within azimuthal magnetic interaction region B-56 while magnetic particle 34 of trajectory path 79 does not. Similarly, the flow rate of mixture 12 must be controlled to ensure proper recovery of magnetic particles 34 in region B-56.

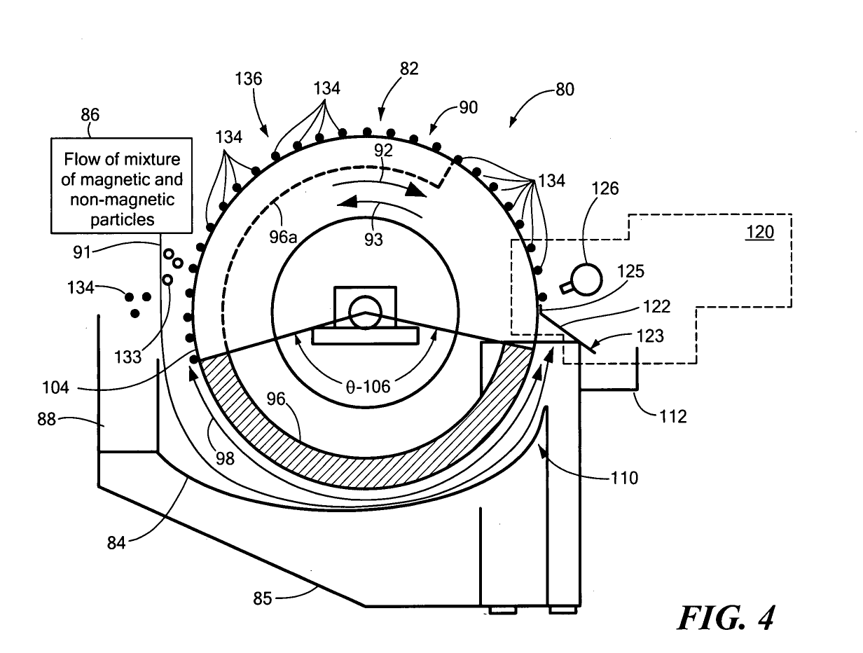

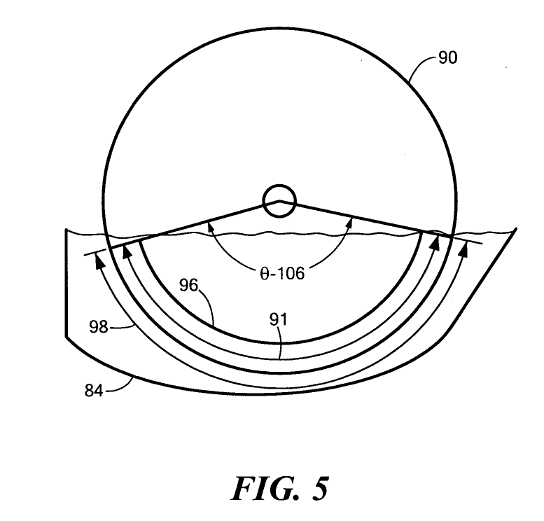

In contrast, improved collection system 80, FIG. 4, for wet drum magnetic separator 82 of this invention includes tank 84 which receives a flow of a mixture of magnetic and non-magnetic particles 86 by feed box 88. Mixture 86 travels in the direction indicated at 91. Mixture 86 may be a feed slurry of magnetic and non-magnetic particles or an effluent having magnetic ballasts resulting from flocculation and sedimentation processes and/or adsorption processes. Wet drum magnetic separator 82 includes rotating drum 90 disposed in tank 84. In this example, drum 90 rotates counter-current of the flow of mixture 86, indicated by arrow 92. In other examples, drum 90 may rotate concurrent as the flow of mixture 86, as shown by arrow 93. Drum 90 includes roughed surface 104 designed to trap the magnetic particles in mixture 86 that adhere to it (discussed below). Array of permanent magnets 96 is disposed inside drum 90 and is arranged in a fixed position relative to an azimuthal section, e.g., section 91, FIG. 5, where like parts have been given like numbers, of drum 90. Array of permanent magnets 96 establishes azimuthal magnetic interaction region 98 that attracts magnetic particles 134, FIG. 4, in mixture 86 to roughened surface 104 on drum 90. Non-magnetic particle discharge port 110 is located on the opposite the side of drum 90 as feed box 88. Magnetic particle discharge port 112 is located next to non-magnetic particle discharge port 112 and located outside of tank 84. Because magnetic particle discharge port 112 is located outside tank 84, azimuthal magnetic interaction region 98 is approximately equal to the maximum available azimuthal length defined by the level of mixture 86 of magnetic particles 134 and non-magnetic particles 135 in tank 84. For example, FIG. 5, shows in further detail azimuthal magnetic interaction region 98 defined by level 102 of mixture 86 of magnetic and non-magnetic particles. In one embodiment, the angle, θ-106, of azimuthal magnetic interaction region 98 is between about 120° to 240°, e.g., at least about 160°. Azimuthal magnetic interaction region, 98, FIGS. 4 and 5, provide a uniform magnetic field for attracting magnetic particles 134 to surface 104 of drum 90. The result is increased recovery of magnetic particles 134 in mixture 86 and increased processing capacity when compared to the conventional concurrent and counter-current rotating wet drum magnetic separators discussed above.

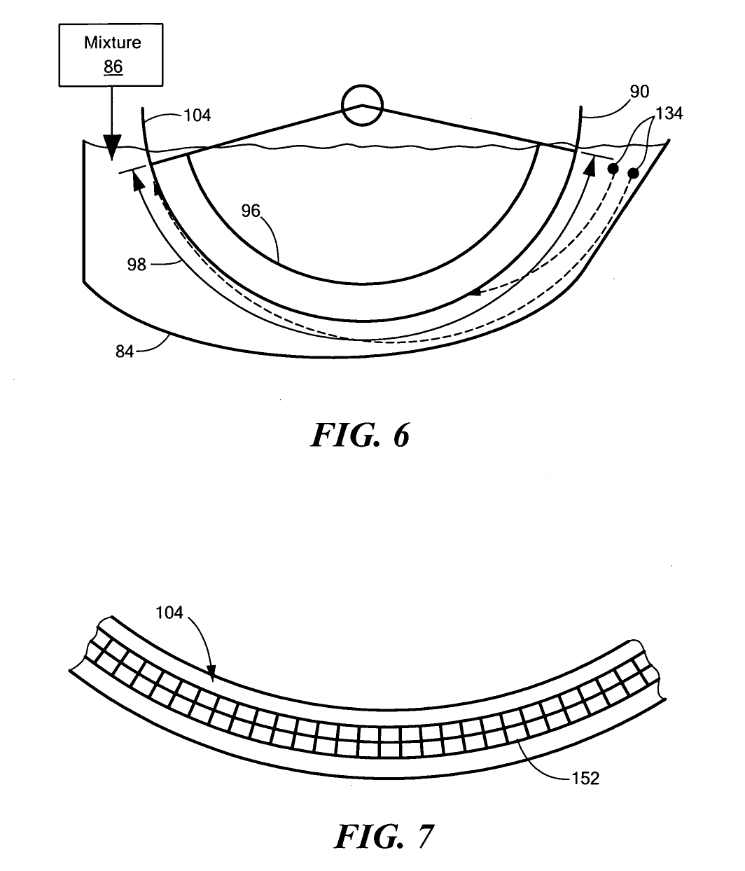

Because processing capacity is directly proportional to the available azimuthal magnetic interaction region, the increased size of azimuthal magnetic interaction region 98 of improved collection system 80, FIG. 4, increases the processing capacity of wet drum magnetic separator 82. For example, FIG. 6, where like parts have been given like numbers, shows trajectory paths 135 and 137 for two magnetic particles 134 in flow of mixture 86 located in azimuthal magnetic interaction region 98 proximate drum 90 of wet drum magnetic separator 82, FIG. 4. In this example, drum 90 is rotating counter-current to flow of mixture 86, as shown by arrow 92. The increased size of azimuthal magnetic interaction region 98 allows the flow rate of mixture 86 to be increased, e.g., in the range of about 120 gpm to about 400 gpm, e.g., about 150 gpm for a drum about 1 m in diameter and about 1 m in length, thus allowing magnetic particles 134 to adhere to surface 104 of drum 90 before they leave azimuthal magnetic interaction region 98 as shown in FIG. 6. The result is improved collection system 80, FIG. 4, increases processing capacity of wet drum magnetic separator 82.

In one design, roughened collection surface 104 is made by attaching wire mesh 152, FIG. 7, to drum 90. Wire mesh 152 may be made of a non-magnetic material such as stainless steel or a ferro-magnetic material such carbon steel. In one example, the wire mesh 152 includes 300 series wire mesh made of stainless steel. In other designs, wire mesh 152 includes a 400 series wire mesh made of a ferro-magnetic material. In yet another design, roughened collection surface 104 may be made of plastic or similar type mesh material, e.g., VELCRO®.

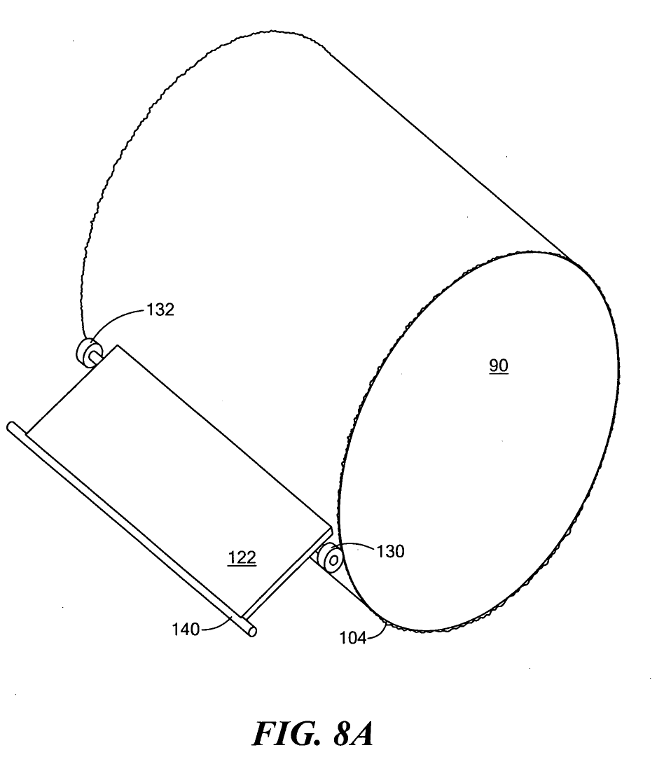

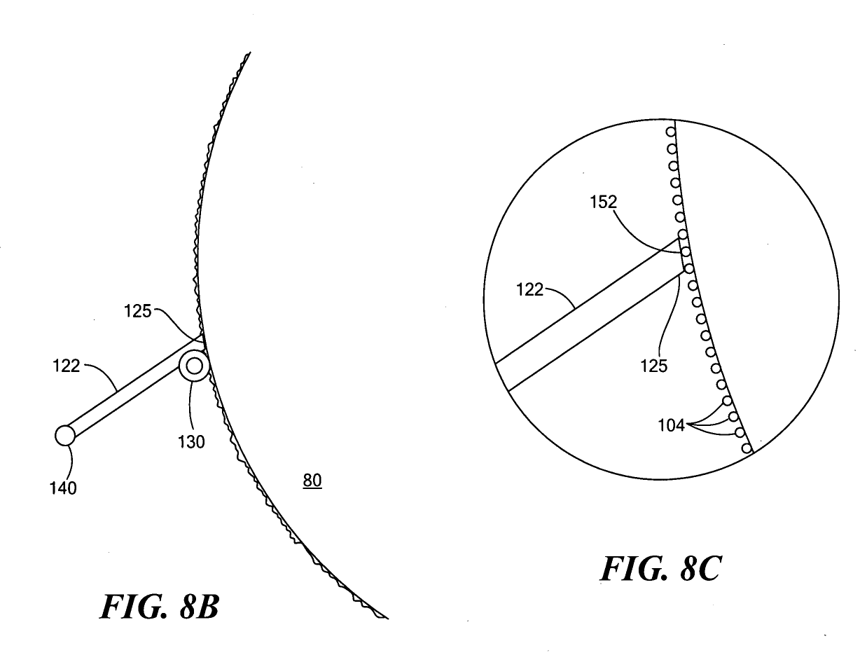

In operation, the magnetic field provided by array of permanent magnets 96, FIGS. 4 and 5, establishes azimuthal magnetic interaction region 98 which causes magnetic particles 134, FIG. 4, in mixture 86 to adhere to roughened surface 104. Non-magnetic particles 135 are discharged to non-magnetic particle discharge port 110 as they leave azimuthal magnetic interaction region 98. In order to accommodate magnetic particle discharge port 112 being located outside of tank 84 and on the opposite side of drum 90 as feed box 88, magnetic particles 134 adhered to roughed collection surface 104 and are carried up and over drum 90 to magnetic particle discharge port 112, e.g., magnetic particles 134 indicated at 136 on drum 90. To facilitate the carrying process, array of permanent magnets 96 may be extended as shown by section 96a. Improved collection system 80 includes collection removal subsystem 120 which removes magnetic particles 134 on drum 96 before they reach magnetic particle discharge port 112. Collection removal subsystem 120 preferably includes scraper 122 which is affixed on end 123 to support structure 85 and disposed on end 125 proximate to roughened surface 104. Scraper 122 removes magnetic particles 134 and dispenses them into magnetic particle discharge port 112. Preferably, scraper 122 includes wheels 130 and 132, FIG. 8A that ride on roughed collection surface 104 of drum 90. In one design, scraper 122 includes support arm 140 that is attached to support structure 85, FIG. 4 connected to tank 84. FIG. 8B shows an enlarged side view of one embodiment of scraper 122 showing wheel 130 riding on roughed collection surface 104 and one exemplary shape of end 125 disposed proximate to roughened collection surface 104. FIG. 8C shows an example of the mating of surface 152 on end 125 of scraper 122 with roughed collection surface 104. Thus, scraper 122 efficiently removes magnetic particles from roughened collection surface 104, while wheels 130 and 132 and support arm 140 prevent excessive wear of scraper 122.

In one embodiment,.collection subsystem 120, FIG. 4, includes at least one spray nozzle, e.g., nozzle 126, which dispenses a fluid, e.g., water, onto roughened surface 104 to further enhance the removal of magnetic particles from roughened surface 104 of drum 90.

The result is improved collection system 80, FIGS. 4-8C, for wet drum magnetic separator 82 of this invention increases the available azimuthal magnetic interaction region which improves recovery of the magnetic particles in a mixture of magnetic and non-magnetic particles and provides for increasing the flow rate of the mixture of magnetic and non-magnetic particles which increases processing capacity and yield. The efficient design and location of the magnetic particle discharge port located on the outside of the tank provides a non-complicated flow path for the flow of mixture which further improves flow capacity and reduces manufacturing costs.

Although the examples discussed above with reference to FIGS. 4-6 primarily show drum 90 rotating counter-current the direction of flow of mixture 86, this is not a necessary limitation of this invention. In other examples in accordance with this invention, drum 90 rotates concurrent the flow of mixture 86, as shown-by arrow 93, FIG. 4. In this design, magnetic particle discharge port 112 and collection removal system 120 are located on the same side as feed box 88.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An improved collection system for a wet drum magnetic separator comprising:
a tank for receiving a flow of a mixture of magnetic and non-magnetic particles in a feed port; and
a collection system including:
a rotating drum having a roughened collection surface disposed in the tank,
an array of permanent magnetic elements disposed inside the drum arranged in a fixed position relative to an azimuthal section of the drum for establishing an azimuthal magnetic interaction region defined by a level of the mixture in the tank for attracting the magnetic particles to the roughened collection surface,
a non-magnetic particle discharge port located on an opposite side of the tank as the flow of the mixture for removing the non-magnetic particles,
a magnetic particle discharge port located outside the tank for receiving the magnetic particles, and
a magnetic particle removal subsystem for removing magnetic particles trapped in the roughed collection surface and dispensing the magnetic particles to the magnetic particle discharge port.

2. The system of claim 1 in which the azimuthal magnetic interaction region is subtended at an angle in the range of about 100° to 240° with respect to the center of the drum.

3. The system of claim 1 in which the azimuthal magnetic interaction region is subtended at an angle of 160°.

4. The system of claim 1 in which the flow of the mixture is fed at a flow rate in the range of about 120 gpm to about 400 gpm.

5. The system of claim 1 in which the flow of the mixture is fed at a flow rate of about 150 gpm.

6. The system of claim 1 in which the magnetic particle removal subsystem includes a scraper engaged with the roughened collection surface.

7. The system of claim 6 in which the scraper includes a plurality of wheels disposed on the roughened collection surface of the drum.

8. The system of claim 6 in which the scraper includes a support arm attached to the tank.

9. The system of claim 6 in which one end of the scraper includes a surface contoured to the shape of the roughened collection surface of the drum.

10. The system of claim 1 in which the magnetic particle removal subsystem includes at least one spray nozzle for dispensing a fluid on the roughened collection surface to enhance removal of the magnetic particles.

11. The system of claim 1 in which the roughened collection surface includes wire mesh.

12. The system of claim 11 in which the wire mesh is made of a non-magnetic material.

13. The system of claim 12 in which the non-magnetic material includes stainless steel.

14. The system of claim 10 in which the rough surface is constituted by VELCRO®.

15. The system of claim 1 in which the drum rotates counter-current the direction of the flow of the mixture.

16. The system of claim 1 in which the drum rotates concurrent the direction of the flow of the mixture.

17. The system of claim 1 in which the magnetic particles include magnetite.

18. An improved collection system for a counter-rotating wet drum magnetic separator comprising:
a tank for receiving a flow of a mixture of magnetic and non-magnetic particles in a feed port, and
a collection system including:
a rotating drum having a roughened collection surface disposed in the tank,
an array of permanent magnetic elements disposed inside the drum arranged in a fixed position relative to an azimuthal section of the drum for establishing an azimuthal magnetic interaction region defined by a level of the mixture in the tank for attracting the magnetic particles to the roughened collection surface,
a non-magnetic particle discharge port located on an opposite side of the tank as the flow of the mixture for removing the non-magnetic particles,
a magnetic particle discharge port located outside the tank for receiving the magnetic particles, and
a magnetic particle removal subsystem for removing magnetic particles trapped in the roughed collection surface and dispensing the magnetic particles to the magnetic particle discharge port.

19. An improved collection system for a concurrent wet drum magnetic separator comprising:
a tank for receiving a flow of a mixture of magnetic and non-magnetic particles in a feed port, and
a collection system including:
a rotating drum having a roughened collection surface disposed in the tank,
an array of permanent magnetic elements disposed inside the drum arranged in a fixed position relative to an azimuthal section of the drum for establishing an azimuthal magnetic interaction region defined by a level of the mixture in the tank for attracting the magnetic particles to the roughened collection surface,
a non-magnetic particle discharge port located on an opposite side of the tank as the flow of the mixture for removing the non-magnetic particles,
a magnetic particle discharge port located outside the tank for receiving the magnetic particles, and
a magnetic particle removal subsystem for removing magnetic particles trapped in the roughed collection surface and dispensing the magnetic particles to the magnetic particle discharge port.
